(19) United States
(12) Patent Application Publication
(10) Pub. No.: US 2016/0323684 A1
(43) Pub. Date: Nov. 3, 2016

(54) AUTHENTICATING CONTENT VIA LOUDNESS SIGNATURE

(71) Applicant: TLS Corp., Cleveland, OH (US)

(72) Inventors: Timothy J. Carroll, Lancaster, PA (US); Erik L. Booth, Landisville, PA (US)

(21) Appl. No.: 14/699,658

(22) Filed: Apr. 29, 2015

(51) Int. Cl. H04R 29/00

(52) U.S. Cl. CPC H04R 29/00

(57) ABSTRACT

A method for authenticating content via loudness signature includes receiving an input signal comprising a) an audio signal of the content and b) metadata including data indicating remotely measured loudness of the content, measuring loudness of the audio signal of the content to obtain a locally measured loudness of the content, and comparing the remotely measured loudness of the content to the locally measured loudness of the content to obtain an authentication indication based on the comparing.

### BACKGROUND

Media content is produced, processed, and then transmitted to consumers. The transmitted content may have been modified along the way. Subsequent to production, the processing, and/or transmitting may result in quality degradation of the media content. For example, audio received at a radio or television station maybe significantly modified by audio processors at the station and, therefore, the resulting broadcasted audio may be significantly different from the original audio. In some cases, the modifications to the audio are so significant that they may be detected by users. In other cases the modifications may be so subtle that they may not be noticeable to users. Regardless, in some cases, it is desirable to understand the modifications being made to the audio.

Accordingly, broadcasters today are continuously challenged with monitoring of media content as the media content is being broadcast to consumers and with balancing the quantity of personnel against the quantity of equipment utilized for the continuous monitoring. Many broadcasters have come to rely on some type of process (or processes) to ensure that content meets their own (often subjective) criteria both before being aired and while being aired. The processes generally include checks at many different steps along the chain from production to broadcasting and may involve a human operator verifying the quality at each of the steps.

### SUMMARY OF THE INVENTION

The present disclosure provides methods and systems that address the problem of authenticating or identifying content. The present disclosure describes a novel technique for authenticating content by comparing a pre-measured loudness measurement embedded within the content against a running measurement of the content itself. The disclosed mechanism enables the verification of the embedded data and thus the authenticity of the content itself.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

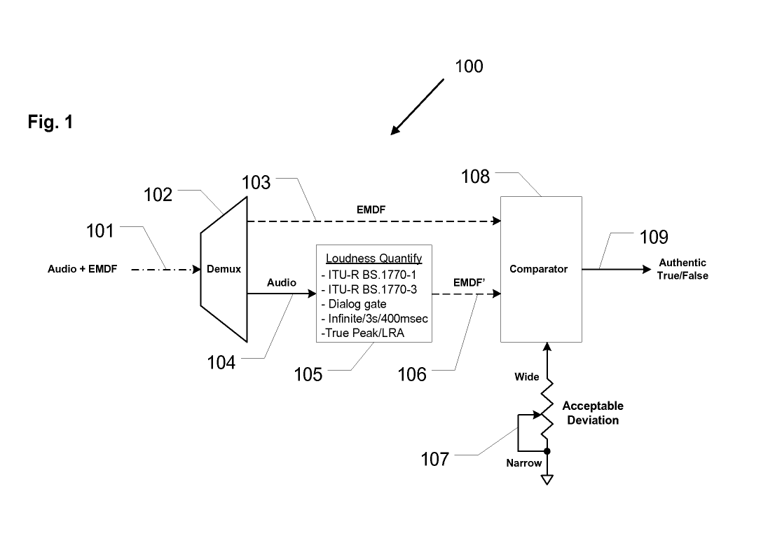

FIG. 1 illustrates a block diagram of exemplary system for authenticating content via its loudness signature.

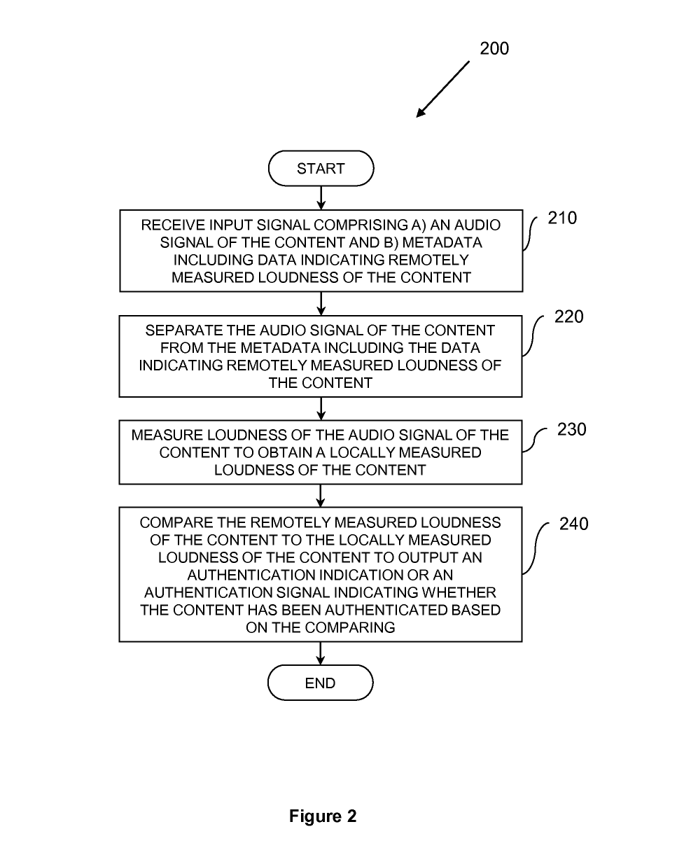

FIG. 2 illustrates a flow diagram for an exemplary method for authenticating content via loudness signature.

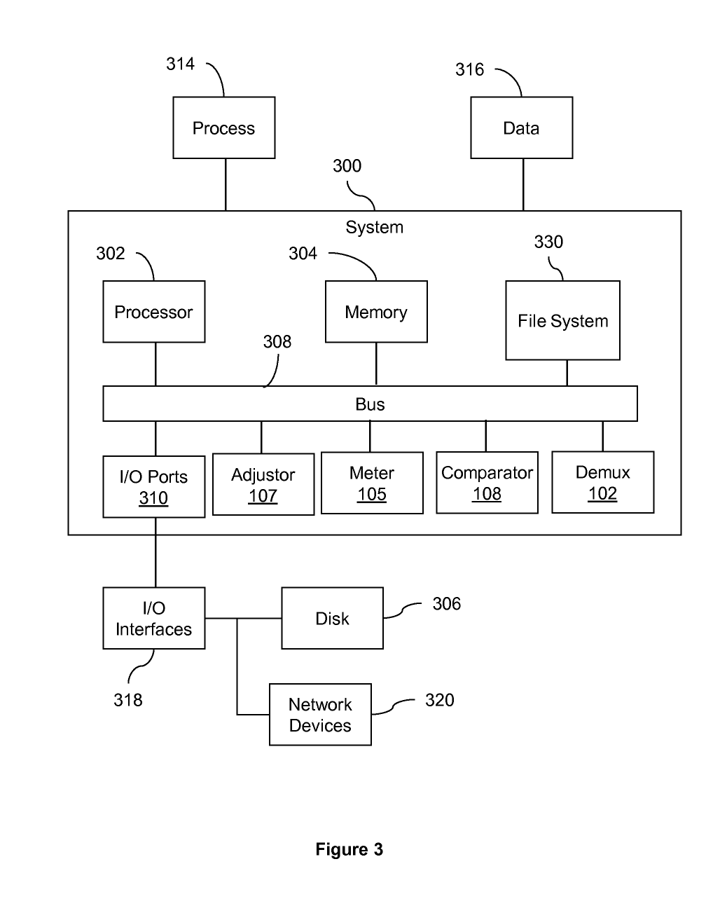

FIG. 3 illustrates a block diagram of an exemplary system for authenticating content via loudness signature.

### DETAILED DESCRIPTION

For ease of explanation, the present disclosure describes examples in the context of the nomenclature described in ETSI TS 102 366 (Annex H) such as, for example, the Extensible Metadata Format (EMDF) used to carry information and control data about audio signals into which it is embedded. The principles of the present disclosure, however, are not limited to that context and may be practiced in various other contexts including any such embedded metadata schemes included with any compressed audio including ETSI TS 103 190 (section 4.3.15) or baseband PCM audio system including metadata as described in ATSC A52:2012 and A/85:2013 or even the SMPTE 337M standard.

Digital audio compression standards such as AC-3 and Enhanced AC-3 described in ETSI TS 102 366 (Annex H) include a so-called Extensible Metadata Format (EMDF) used to carry information and control data about the audio signals into which it is embedded. AC-4 described in ETSI TS 103 190 (section 4.3.15) includes a very similar Universal Metadata (UMD) format to carry information and control data about the audio signals into which it is embedded. There is also work in process to include this metadata outside of specific audio codecs as an additional data type as part of the SMPTE 337M standard.

The metadata is normally created upstream, usually by automatic means in an offline manner where the entire program or program segment can be quantified. However, it is also possible to obtain most of the relevant data for live content as well.

Per ETSI TS 102 366 (Annex H): this EMDF metadata “may be used to describe the nature or configuration of the audio programme being delivered in an AC-3 or Enhanced AC-3 bit stream, or may be used to control audio processing algorithms that are designed to further process the output of the AC-3 or Enhanced AC-3 decoder.”

The metadata format is a container that includes one or more data payloads. The payload ID 0x1—“Programme Loudness Data” includes data indicating the measured loudness value of the program and the method or methods which were used to make the measurement.

Loudness values measured per ITU-R BS.1770-1 with and without speech gating and ITU-R BS.1770-3 using relative gating are available as infinite loudness, which is pre-measured over the entire length of the program, short term loudness measured with a 3-second or 10-second integration, and momentary loudness measured with a 400 msec integration. True Peak (TP) and loudness range (LRA) are also available. Also available are indications of whether the loudness data was obtained over the full length of the program (offline) or real-time (online) in which case the infinite loudness measure would be only a rolling estimate.

The measured loudness value or values of content may be characterized as a “loudness signature” of the content. That is, the content may be uniquely identified or authenticated by measuring loudness locally and comparing the local measurement to, for example, a remote loudness measurement taken at the source of the content. The remote loudness measurement included within, for example, payload ID 0x1—“Programme Loudness Data” may be compared to a local loudness measurement to authenticate the content.

Upon receiving the audio and metadata container, the content may be applied to a set of “live” meters that are identical to the set used remotely at the source including, for example, ITU-R BS.1770-1 with and without speech gating and ITU-R BS.1770-3 using relative gating, as well as TP and LRA meters.

In summary, the present disclosure describes methods and systems whereby the local “live” loudness measurement values are compared to the corresponding remote loudness measurement remote values carried by metadata, and the authenticity of the content can be verified within an adjustable range by means of that comparison.

FIG. 1 illustrates a block diagram of exemplary system 100 for authenticating content via its loudness signature. The system 100 includes an input 101 that receives an input signal Audio+EMDF comprising, for example, a baseband PCM or AC-3, E-AC-3, AC-4 compressed digital audio signal and an associated enhanced metadata (EMDF) bit stream or equivalent metadata (e.g., Universal Metadata (UMD), etc.) The metadata EMDF 103 includes data indicating remotely measured loudness of the Audio 104.

In the illustrated embodiment, the system 100 includes a demultiplexer 102 to which the input signal is applied. Demux 102 separates the Audio 104 and the EMDF data 103 from the input signal.

The system 100 also includes a loudness quantification section 105 to which the Audio 104 is applied to locally measure the loudness of the Audio 104 in the same (or similar) manner that the content was measured remotely. For example, the loudness quantification section 105 may include one or more meters to locally measure the loudness of the Audio 104 per ITU-R BS.1770-1 with and without dialogue gating, and BS.1770-3 all with integration times including infinite, 10 seconds, 3 seconds, and 400 msec. True Peak and Loudness Range meters may also be used. The output EMDF′ 106 of the loudness quantification section 105 may essentially be a real-time version of the enhanced metadata EMDF 103.

The system 100 also includes a comparator 108 to which the EMDF 103 and the EMDF′ 106 may be applied. The comparator 108 compares the remotely measured loudness of the content as included in the EMDF 103 to the locally measured loudness of the content as included in the EMDF′ 106 to obtain an authentication indication based on the comparison. The authentication indication may be compared to a threshold level or range corresponding to an acceptable difference range between the locally measured loudness values in EMDF′ 106 and the remotely measured loudness values in EMDF 103 within which authentication of the Audio 104 may be declared.

The system 100 may also include an acceptable deviation control or adjustor 107 that may be used to define the acceptable difference range between the locally measured loudness values in EMDF′ 106 and the remotely measured loudness values in EMDF 103 within which authentication of the Audio 104 may be declared.

Provided the Audio 104 has not been modified, the non-infinite integration times in EMDF′ data 106 will accurately match those contained in the EMDF data 103 within the range set by control 107. If so, then output 109 will be true, indicating the relationship between the Audio 104 and EMDF data 103 is authentic, else the output 109 is false.

Potential acceptable deviation ranges for control 107 within which authentication of the Audio 104 may be declared include, for example, +/−0.1 dB for 400 msec integration time, +/−0.25 dB for 3 second integration time, +/−0.5 dB for 10 second integration time, etc. Local loudness measurement values outside of these examples may be declared false or not authenticating. In other examples, different ranges may be used.

Local loudness measurement values outside of these exemplary ranges may correspond to degradation of Audio 104, for example, because of excessive audio processing. With this information, an audio processor, for example, that caused the degradation of the content, Audio 104, may be identified. Thereafter the identified audio processor that caused the degradation of the content may be removed, replaced, or corrected to reduce or eliminate the degradation.

The system 100 may be implemented using software, hardware, analog or digital techniques and can run real time or faster or slower than real time or some hybrid of all of these.

Exemplary methods may be better appreciated with reference to the flow diagram of FIG. 2. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an exemplary methodology. Furthermore, additional methodologies, alternative methodologies, or both can employ additional blocks, not illustrated.

In the flow diagram, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

FIG. 2 illustrates a flow diagram for an exemplary method 200 for authenticating content via loudness signature. The method 200 includes at 210 receiving an input signal comprising a) an audio signal of the content and b) metadata including data indicating remotely measured loudness of the content. At 220, the method 200 includes separating the audio signal of the content from the metadata including the data indicating remotely measured loudness of the content. At 230, the method 200 includes measuring loudness of the audio signal of the content to obtain a locally measured loudness of the content. At 240, the method, 200 includes comparing the remotely measured loudness of the content to the locally measured loudness of the content to output an authentication indication or an authentication signal indicating whether the content has been authenticated based on the comparing.

In one embodiment, the method 200 includes comparing the authentication indication to a threshold level or range, and outputting the authentication signal indicating whether the content has been authenticated based on the comparing the authentication indication to the threshold level or range. In one embodiment, the method 200 includes adjusting the threshold level or range to adjust an acceptable deviation range between the remotely measured loudness of the content and the locally measured loudness of the content.

While FIG. 2 illustrates various actions occurring in serial, it is to be appreciated that various actions illustrated could occur substantially in parallel, and while actions may be shown occurring in parallel, it is to be appreciated that these actions could occur substantially in series. While a number of processes are described in relation to the illustrated methods, it is to be appreciated that a greater or lesser number of processes could be employed and that lightweight processes, regular processes, threads, and other approaches could be employed. It is to be appreciated that other exemplary methods may, in some cases, also include actions that occur substantially in parallel. The illustrated exemplary methods and other embodiments may operate in real-time, faster than real-time in a software or hardware or hybrid software/hardware implementation, or slower than real time in a software or hardware or hybrid software/hardware implementation.

FIG. 3 illustrates a block diagram of an exemplary system 300 for authenticating content via loudness signature. The system 300 includes a processor 302, a memory 304, and I/O Ports 310 operably connected by a bus 308.

In one example, the system 300 may receive an input signal comprising a) an audio signal of the content and b) metadata including data indicating remotely measured loudness of the content via, for example, I/O Ports 310 or I/O Interfaces 318. The system 300 may also include a meter 105 configured to measure loudness of the audio signal of the content to obtain a locally measured loudness of the content. The system 300 may also include a comparator 108 configured to compare the remotely measured loudness of the content to the locally measured loudness of the content to obtain an authentication indication based on the comparing. The system 300 may also include a demultiplexer 102 configured to separate the audio signal of the content from the metadata including the data indicating remotely measured loudness of the content prior to the meter measuring loudness of the audio signal of the content to obtain the locally measured loudness of the content. The system 300 may also include an adjustor 107 configured to adjust the threshold level or range to adjust an acceptable deviation range between the remotely measured loudness of the content and the locally measured loudness of the content. Thus, the demux 102, the meter 105, the adjustor 107 and the comparator 108 may be implemented in system 300 as hardware, firmware, software, or a combination thereof and may provide means for performing their respective functions as described herein.

The processor 302 can be a variety of various processors including dual microprocessor and other multi-processor architectures. The memory 304 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 306 may be operably connected to the system 300 via, for example, an I/O Interfaces (e.g., card, device) 318 and an I/O Ports 310. The disk 306 can include, but is not limited to, devices like a magnetic disk drive, a solid state disk drive, a floppy disk drive, a tape drive, a Zip drive, a flash memory card, or a memory stick. Furthermore, the disk 306 can include optical drives like a CD-ROM, a CD recordable drive (CD-R drive), a CD rewriteable drive (CD-RW drive), or a digital video ROM drive (DVD ROM). The memory 304 can store processes 314 or data 316, for example. The disk 306 or memory 304 can store an operating system that controls and allocates resources of the system 300.

The bus 308 can be a single internal bus interconnect architecture or other bus or mesh architectures. While a single bus is illustrated, it is to be appreciated that system 300 may communicate with various devices, logics, and peripherals using other busses that are not illustrated (e.g., PCIE, SATA, Infiniband, 1394, USB, Ethernet). The bus 308 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The system 300 may interact with input/output devices via I/O Interfaces 318 and I/O Ports 310. Input/output devices can include, but are not limited to, a keyboard, a microphone, a pointing and selection device, cameras, video cards, displays, disk 306, network devices 320, and the like. The I/O Ports 310 can include but are not limited to, serial ports, parallel ports, and USB ports.

The system 300 can operate in a network environment and thus may be connected to network devices 320 via the I/O Interfaces 318, or the I/O Ports 310. Through the network devices 320, the system 300 may interact with a network. Through the network, the system 300 may be logically connected to remote computers. The networks with which the system 300 may interact include, but are not limited to, a local area network (LAN), a wide area network (WAN), and other networks. The network devices 320 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the network devices 320 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

### DEFINITIONS

The following includes definitions of selected terms employed herein. The definitions include various examples or forms of components that fall within the scope of a term and that may be used for implementation. The examples are not intended to be limiting. Both singular and plural forms of terms may be within the definitions.

“Content” corresponds to still images, segments of audio media, video media, or audio/visual (AV) media and include information that is embodied, stored, transmitted, received, processed, or otherwise used with at least one medium. Common media content formats include FLV format (flash video), Windows Media Video, RealMedia, Quicktime, MPEG, MP3, DivX, JPEGs, and Bitmaps. As used herein, the terms “media clips”, “media content,” “information content,” and “content” may be used interchangeably.

“Data store,” as used herein, refers to a physical or logical entity that can store data. A data store may be, for example, a database, a table, a file, a list, a queue, a heap, a memory, a register, and so on. A data store may reside in one logical or physical entity or may be distributed between two or more logical or physical entities.

“Logic,” as used herein, includes but is not limited to hardware, firmware, software or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Signal,” as used herein, includes but is not limited to one or more electrical or optical signals, analog or digital signals, data, one or more computer or processor instructions, messages, a bit or bit stream, or other means that can be received, transmitted, or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servlet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing the various components of the example systems and methods described herein may be produced using programming languages and tools like Java, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1. A method for authenticating content via loudness signature, the method comprising:
receiving an input signal comprising a) an audio signal of the content and b) metadata including data indicating remotely measured loudness of the content;
measuring loudness of the audio signal of the content to obtain a locally measured loudness of the content; and
comparing the remotely measured loudness of the content to the locally measured loudness of the content to obtain an authentication indication based on the comparing.

2. The method of claim 1, comprising:
separating the audio signal of the content from the metadata including the data indicating remotely measured loudness of the content prior to measuring loudness of the audio signal of the content to obtain the locally measured loudness of the content.

3. The method of claim 1, wherein:
the audio signal correspond to an AC-3 standard signal and the metadata to Extensible Metadata Format (EMDF);
the audio signal correspond to an AC-4 standard signal and the metadata to Universal Metadata (UMD) format; or
the audio signal correspond to a PCM audio signal and the metadata to corresponding metadata.

4. The method of claim 1, wherein the remotely measured loudness of the content and the locally measured loudness of the content are measured per at least one of:
ITU-R BS.1770-1 with speech gating,
ITU-R BS.1770-1 without speech gating, and
ITU-R BS.1770-3 using relative gating.

5. The method of claim 1, wherein the remotely measured loudness of the content and the locally measured loudness of the content are measured with at least one of:
a 10-second integration,
a 3-second integration,
a 400 msec integration,
a True Peak (TP) meter, and
a loudness range (LRA) meter.

6. The method of claim 1, comprising:
outputting an authentication signal indicating whether the content has been authenticated based on the authentication indication.

7. The method of claim 1, comprising:
comparing the authentication indication to a threshold level or range; and
outputting an authentication signal indicating whether the content has been authenticated based on the comparing the authentication indication to the threshold level or range.

8. The method of claim 7, comprising:
adjusting the threshold level or range to adjust an acceptable deviation range between the remotely measured loudness of the content and the locally measured loudness of the content.

9. A system for authenticating content via loudness signature, the system comprising:
an input configured to receive an input signal comprising a) an audio signal of the content and b) metadata including data indicating remotely measured loudness of the content;
a meter configured to measure loudness of the audio signal of the content to obtain a locally measured loudness of the content; and
a comparator configured to compare the remotely measured loudness of the content to the locally measured loudness of the content to obtain an authentication indication based on the comparing.

10. The system of claim 9, comprising:
a demultiplexer configured to separate the audio signal of the content from the metadata including the data indicating remotely measured loudness of the content prior to the meter measuring loudness of the audio signal of the content to obtain the locally measured loudness of the content.

11. The system of claim 9, wherein:
the audio signal correspond to an AC-3 standard signal and the metadata to Extensible Metadata Format (EMDF);
the audio signal correspond to an AC-4 standard signal and the metadata to Universal Metadata (UMD) format; or
the audio signal correspond to a PCM audio signal and the metadata to corresponding metadata.

12. The system of claim 9, wherein the remotely measured loudness of the content and the locally measured loudness of the content are measured per at least one of:
ITU-R BS.1770-1 with speech gating,
ITU-R BS.1770-1 without speech gating, and
ITU-R BS.1770-3 using relative gating.

13. The system of claim 9, wherein the remotely measured loudness of the content and the locally measured loudness of the content are measured with at least one of:
a 10-second integration,
a 3-second integration,
a 400 msec integration,
a True Peak (TP) meter, and
a loudness range (LRA) meter.

14. The system of claim 9, wherein the comparator is configured to output an authentication signal indicating whether the content has been authenticated based on the authentication indication.

15. The system of claim 9, wherein the comparator is configured to compare the authentication indication to a threshold level or range, and to output an authentication signal indicating whether the content has been authenticated based on the comparing the authentication indication to the threshold level or range.

16. The system of claim 15, comprising:
an adjustor configured to adjust the threshold level or range to adjust an acceptable deviation range between the remotely measured loudness of the content and the locally measured loudness of the content.

17. A method for authenticating content via loudness signature, the method comprising:
receiving an input signal comprising a) an audio signal of the content and b) metadata including data indicating remotely measured loudness of the content;
separating the audio signal of the content from the metadata including the data indicating remotely measured loudness of the content;
measuring loudness of the audio signal of the content to obtain a locally measured loudness of the content; and
comparing the remotely measured loudness of the content to the locally measured loudness of the content to output an authentication signal indicating whether the content has been authenticated based on the comparing.

18. The method of claim 17, comprising:
adjusting an acceptable deviation range between the remotely measured loudness of the content and the locally measured loudness of the content to be used when determining whether the content has been authenticated based on the comparing.

19. The method of claim 17, wherein the measuring includes measuring using at least one of:
ITU-R BS.1770-1 with speech gating,
ITU-R BS.1770-1 without speech gating,
ITU-R BS.1770-3 using relative gating,
a 10-second integration,
a 3-second integration,
a 400 msec integration,
a True Peak (TP) meter, and
a loudness range (LRA) meter.

20. The method of claim 17, wherein:
the audio signal correspond to an AC-3 standard signal and the metadata to Extensible Metadata Format (EMDF);
the audio signal correspond to an AC-4 standard signal and the metadata to Universal Metadata (UMD) format; or
the audio signal correspond to a PCM audio signal and the metadata to corresponding metadata.
